(19) United States
(12) Patent Application Publication
(10) Pub. No.: US 2011/0197777 A1
(43) Pub. Date: Aug. 18, 2011

(54) VARIABLE PRINT LITHOGRAPHIC PRINTING PRESS

(76) Inventor: Douglas Lowell OSTERBERG, Menasha, WI (US)

(21) Appl. No.: 13/027,838

(22) Filed: Feb. 15, 2011

Related U.S. Application Data
(60) Provisional application No. 61/305,060, filed on Feb. 16, 2010.

(51) Int. Cl. B41F 31/02

(52) U.S. Cl. 101/350.1; 101/364; 101/483

(57) ABSTRACT

A fountain solution applicator for a printing press, a printing press having at least one fountain solution applicator and a method for applying an image to a substrate are provided. With the applicator, a variable image can be formed whereby the image can be frequently changed. The number of printings for an image can be varied for each item printed or for any desired number of printing cycles.

### BACKGROUND OF THE INVENTION

Lithographic printing functions by placing water and ink on the non-image and image carrying surfaces of a printing plate, respectively, and then transferring the ink from the image carrying area of the printing plate to a printing blanket which transfers it to a printable substrate such as paper. The isolation of ink carrying regions of the printing plate is accomplished by developing the non-image areas to be hydrophilic (water attracting) while developing the imaging regions to be oliophilic (oil and ink attracting and water repelling). Different techniques are used to develop printing plates into these separate regions, but they all deliver the separate ink attractive and water attractive regions and thus afford crisp, defined images of ink to be transferred from the printing plate to the printing blanket to the substrate (e.g. paper).

As a printing plate mounted on a lithographic printing press cylinder rotates, fountain solution (water with various additives) is attracted to the non-image areas of the plate, and it is repelled from the image areas of the plate. Several different methods of fountain solution applications exist, but all result in a thin layer of this fountain solution covering the non-image areas of the plate. When the plate continues to rotate, ink is next applied and is attracted to the image areas of the plate, but it is repelled from the fountain solution wetted areas. Thus, a distinct ink image is formed that is then transferred to a printing blanket that further transfers it to the printable substrate (paper, film, etc.).

Fountain solution is attracted to the hydrophilic regions of the printing plate, and lithographic ink is attracted to the oliophilic regions of the printing plate. Specifically, it is noted that the oliophilic regions are also hydrophobic, or water repelling, and thus, they do not attract the fountain solution during its application to the plate, leaving these regions to attract ink and form an image.

Lithographic printing is often referred to as “offset” printing, referring to the ink image “offsetting” onto the printing blanket and then to the printable substrate. In its basic form, only one image can be produced using one printing plate, given that the image (ink) and non-image (fountain solution) regions are set and fixed during the process of developing the printing plate. It is not impossible to chemically redevelop the physical plate, for which the base material is typically anodized aluminum but may be of other substance, with a new array of image and non-image areas, but in most cases it is commercially advantageous to simply develop a new plate. Regardless, up to tens and even hundreds of thousands of printed signatures may be produced using one printing plate, but as such, every one of these signatures will have a one-color printed image identical to each other. Subsequent printing units or towers can be arranged in sequence to then apply the complement of other images in different colors needed to form a final, multicolor printed form that delivers from the complete printing operation.

New techniques have been developed to exchange printing plates quickly or to develop their image or non-image areas quickly, even in some cases while mounted on the printing press cylinders. This enhances the commercial flexibility and value, but it still requires new plates and/or images to be developed each time a new printed image is desired. Likewise, new techniques have been developed to achieve target inking levels quickly so as to minimize both the time and waste related to reaching acceptable printed image quality. This waste includes ink but more significantly substrate material, which for short run projects may actually exceed the quantity required to produce the salable, final printed quantity of production. The associated “make-ready” costs are typically spread over many printed signatures to allow for commercially acceptable cost per printed unit, or otherwise it adds significantly to the unit cost of each printed signature. Thus, the minimum economical order quantity for printing using the traditional lithographic offset process is normally hundreds or thousands of units, and quantities less than this are trending toward the various toner or inkjet variable-data or “digital” printing processes that are evolving.

New printing techniques have evolved over the past few decades that are challenging the traditional lithographic printing method's inflexibility to change printed images. “Digital” presses, so identified because of their ability to print varied images on every printed signature or at least for small quantities of images, are gaining presence in the commercial printing markets. These include, most commonly, different types of toner or inkjet presses, the latter including either solvent or aqueous based inking systems. These digital presses produce direct images onto printable substrates normally by some means of direct application of ink or toner and usually not by transferring the image to a printing blanket that transfers it to the substrate as is done on a lithographic offset printing press. In particular, inkjet printing utilizes a method of ejecting tiny droplets of ink in a defined pattern directly onto the substrate, thereby providing a non-contacting means of delivering the ink to the substrate.

One simplified, traditional lithographic offset printing press is shown in FIG. 1. This press includes a printing plate cylinder 14, with a series of traditional fountain solution rollers and a series of ink rollers 12. Fountain solution is applied by the traditional fountain solution applicator 24b to the printing plate mounted on the surface of printing plate cylinder 14. Ink is applied to the printing plate by the ink rollers 12. An image is then temporarily adhered to the printing plate mounted on the surface of cylinder 14. This image is transferred to the printing blanket 16 and then to a substrate 22. An impression cylinder 18 is provided to form a nip with the printing blanket 16 mounted on the surface of a rotatable cylinder.

To indicated how simplified this embodiment of FIG. 1 is, FIG. 2 has been included to show a traditional printing press with only the printing plate cylinder 14 being illustrated. FIG. 2 shows an example of a commercial printing press with multiple fountain solution rollers 24′ including rollers Z, W, Y, V and X that carry fountain solution from a pan 60 containing said fountain solution. It also shows in this example of a commercial printing press a plurality of ink rollers 12′ including rollers A, B, C and D in contact with the printing cylinder 14. Additional rollers include J, Q, K, (R), (O), N, I, M, G, K, (H), J, G, N, J, E, F, (P) and L. These ink rollers 12′ effectively spread evenly the ink onto the printing plate which is mounted onto the surface of the printing plate cylinder 14.

### OBJECTS OF THE INVENTION

It is an object of the invention is to provide a fountain solution applicator for a printing press having a printing plate, the applicator having an outlet for releasing fountain solution onto the plate in variable image form whereby the image is frequently changeable.

A further object of the invention is to provide a printing press having a rotatable printing plate, a rotatable printing blanket and a rotatable impression cylinder. A path for a substrate to receive an image is formed between the printing blanket and the impression cylinder. The printing press further has an applicator for applying a fountain solution to the printing plate.

Yet another object of the invention is to provide a method for applying an image to a substrate. The method comprises the steps of providing a printing press with a rotatable printing plate, applying a fountain solution in a predetermined pattern from an applicator onto the printing plate, supplying ink to the printing plate, the ink temporarily adhering to the plate in areas which are free of the fountain solution applied to the plate; and transferring the ink from the plate to a printing blanket and subsequently to the substrate to form an image thereon.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus do not limit the example embodiments.

FIG. 1 illustrates a simplified version of a traditional lithographic offset printing press;

FIG. 2 illustrates one embodiment of a traditional lithographic offset printing press with more of the details shown;

FIG. 3 illustrates a lithographic offset printing press with the fountain solution variable pattern applicator of the present invention;

FIG. 4 illustrates another embodiment of a lithographic offset printing press with a belt style continuous printing plate of the present invention

FIG. 5 illustrates another embodiment of a lithographic offset printing press of the present invention used in combination with components of a traditional lithographic offset printing press;

FIG. 6 graphically explains the variation in images on sequential printed substrate when segmenting the print plate when using the present invention and

FIG. 7 shows an embodiment using a single roller with the fountain solution applicator of the embodiment of FIG. 3 or 5;

FIG. 8 shows another embodiment using a plurality of rollers with the fountain solution applicator of the embodiment of FIG. 3 or 5; and

FIG. 9 shows a plurality of towers in a printing press in a printing press of the present invention.

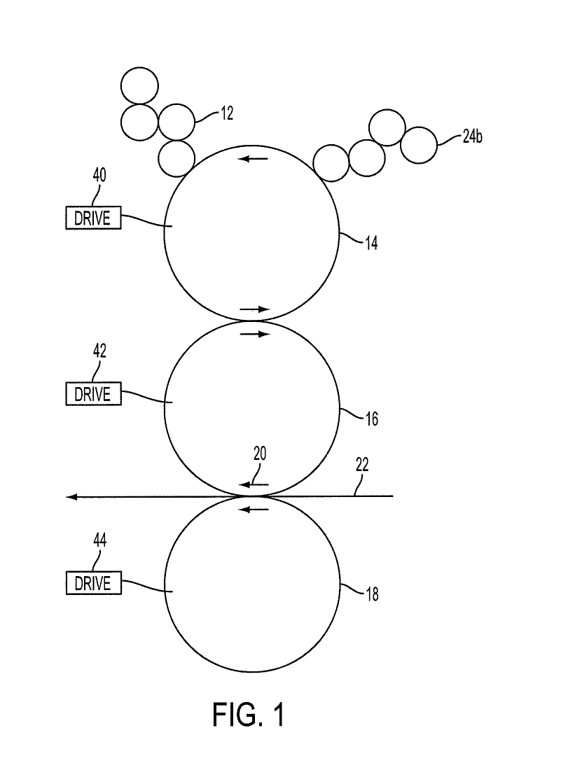

### DETAILED DESCRIPTION OF THE INVENTION

The present invention will present a new way of applying fountain solution to a printing plate on an offset printing press so as to create the non-image fountain solution wetted area of the printing plate quickly and reversibly. It will provide a way of changing the printable image often, perhaps even every rotation of the printing plate cylinder, which will allow the image printed on each signature of the substrate to change frequently, with minimal substrate waste, and without exchanging the actual plate material. Of course, any desired number of images can be printed with the present invention before the image is varied. The printing press can change the image with each rotation of the printing plate cylinder, but it can do so after producing dozens or hundreds or thousands of identical images whereafter the image is then changed to another image with very little waste.

The present invention will allow each individual printed image to be different and distinct from each other “signature”. At a minimum, the method described will allow for a frequent and low cost way of changing the image printed, so that run lengths can be reduced in number, and so that setup costs and startup ink and substrate waste can be greatly reduced compared to traditional lithographic offset printing.

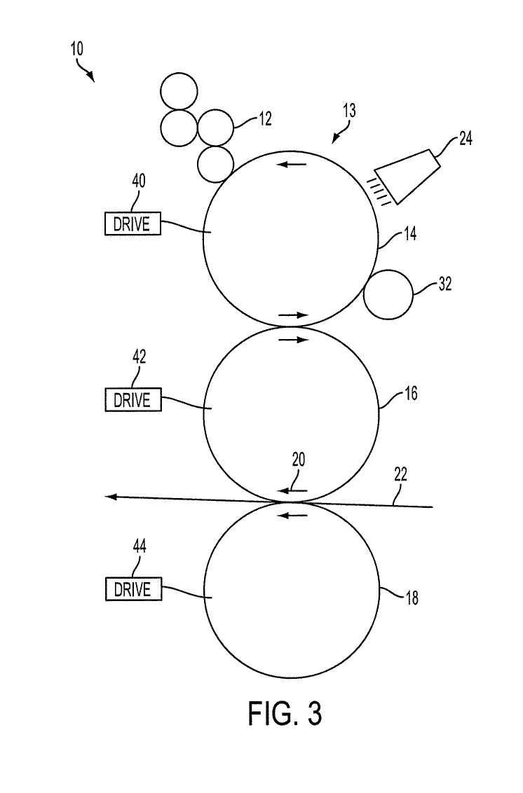

As shown in FIG. 3, the present invention includes an offset printing press 10 wherein the inking system 12, printing plate 13, printing blanket 16, backing or impression cylinder 18 and substrate (paper) path 20 through the press are typical of traditional lithographic offset printing presses. The inking system 12 shown in FIG. 3 is a series of ink rollers; however, a single roller or any other ink application device could be utilized. The printing plate 13 in FIG. 3 is in the form of a printing plate mounted onto the surface of printing cylinder 14, but other printing arrangements can be used as will be explained. The printing blanket 16 is shown on a rotatable cylinder, but again other known arrangements are possible. The substrate 22 can include paper of various stocks, paperboard, cardboard, plastic, glass, metal or any other known substrate, in either sheet-fed or continuous web form. Schematically show in FIG. 3 are drives 40, 42 and 44 for the printing plate cylinder 14, cylinder for the printing blanket 16 and impression cylinder 18. Separate drives can be provided for each or they can be interconnected. Other rollers and elements of the invention can also be driven in a known manner. The printing plate cylinder 14, printing blanket cylinder and impression cylinder are driven to rotate as indicated by the arrows show in the figure.

The offset printing press 10 also includes a system to apply the fountain solution to the printing plate 13 on printing plate cylinder 14. In the embodiment of FIG. 3, this system includes a fountain solution applicator 24. While one applicator 24 is shown, it should be appreciated that plural applicators arranged in a variety of positions can be provided. Some of these arrangements will be discussed in further detail hereinbelow. The fountain solution is applied to the printing plate 13 while it is rotating on printing plate cylinder 14 and is applied in variable image form, meaning specifically that the fountain solution pattern may be changed frequently, including on each rotation of the printing plate cylinder 14. Any sequence of applications can be carried out. For example, the solution pattern may be changed on each rotation, every other rotation, every tenth, every hundredth or any other desired combination of rotations. Great flexibility is provided with the present invention. Moreover, different portions of an image on the substrate 22 can be selectively varied as will be explained below. The application method for the fountain solution includes ejecting droplets of fountain solution in a pre-defined array that will attach to the printing plate 13 and will maintain therewith a reverse image of the ink that will next attract to the areas of the plate not containing the fountain solution. The droplets will be controlled whereby a sharp, detailed image can be produced. The fountain solution on the printing plate 13 will repel the ink from the non-image areas because of its oliophobic, ink-repelling nature, just as happens during traditional lithographic printing, except wherein there the image and non-image areas are fixed. A cleaning roll or other cleaning device 32 is provided upstream of the fountain solution applicator 24. This cleaning device 32 is adjacent the printing plate 13 and downstream from the nip between the printing blanket 16 and the impression cylinder 18.

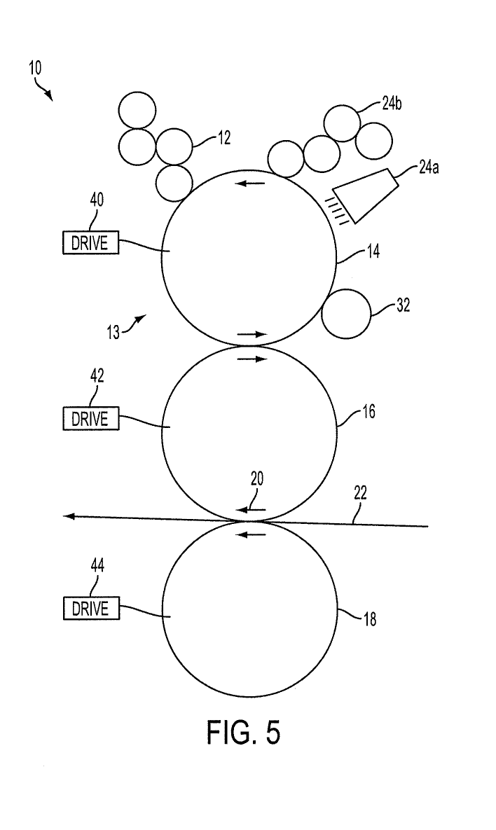

While FIG. 3 illustrates a single fountain solution applicator 24, plural applicators can be used if desired. These can be spaced longitudinally along the length of the printing plate 13 or can be placed in series in the rotation direction of the printing plate. Alternatively, the fountain solution applicator 24 can be used with traditional applicators as will be explained below with regard to the embodiment of FIG. 5. Of course, any combination of fountain solution applicators could be used.

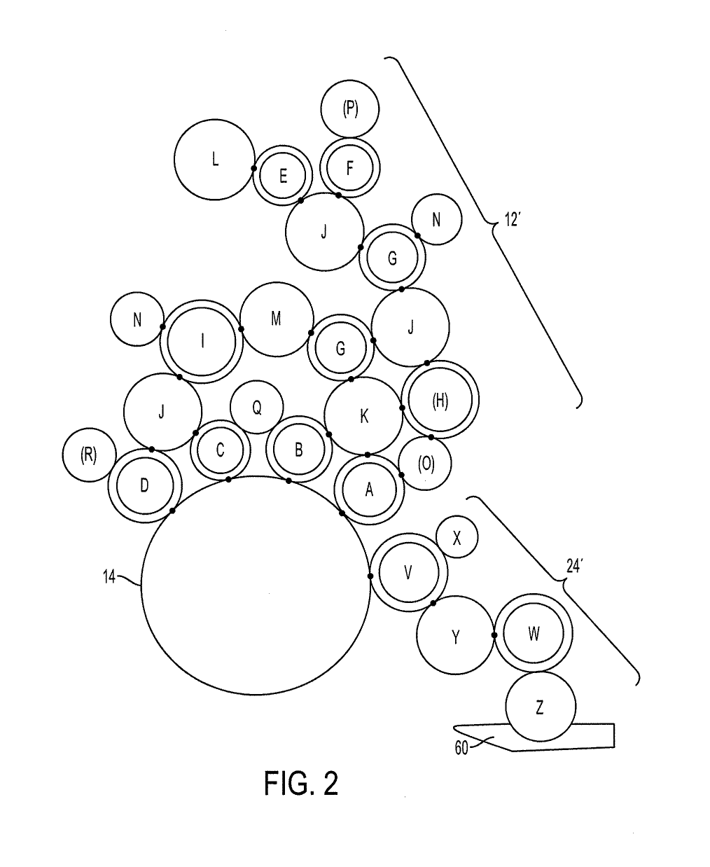

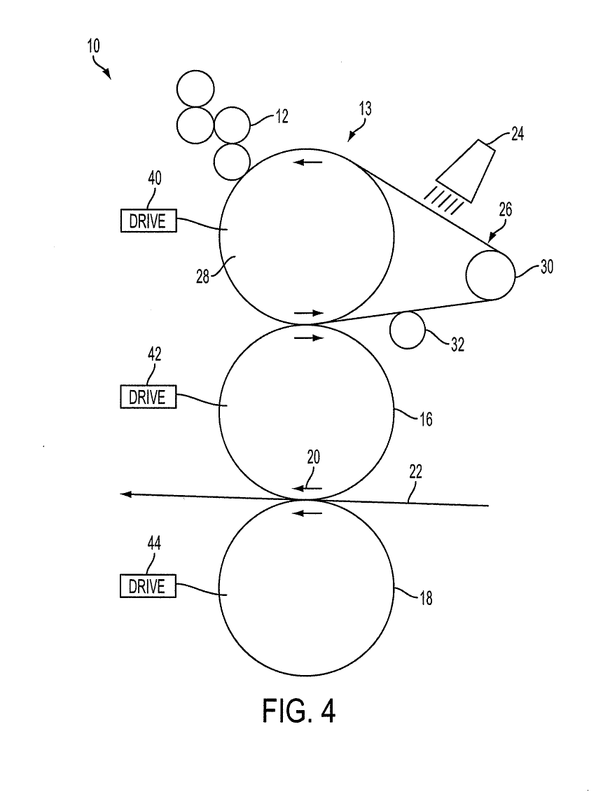

Turning now to FIG. 4 another embodiment of the present invention is shown. Much of the offset printing press is the same as that of FIG. 3 and hence its description will not be repeated. However, instead of ejecting droplets of fountain solution directly onto the printing plate 13 which is mounted onto the surface of printing plate cylinder 14 as is shown in FIG. 3, a belt printing plate 26 is provided. This belt printing plate 26 acts as the printing plate 13 in this embodiment. The fountain solution will be ejected directly by the applicator 24 onto the moving belt printing plate 26. While a drive 40 is shown connected to the underlying cylinder 28 which formerly had the printing plate, this drive 40 can also be attached to the roller 30. Various known driving arrangements are possible. When viewing FIG. 2, many different roller and/or belt arrangements could be contemplated for use with all embodiments of the present invention.

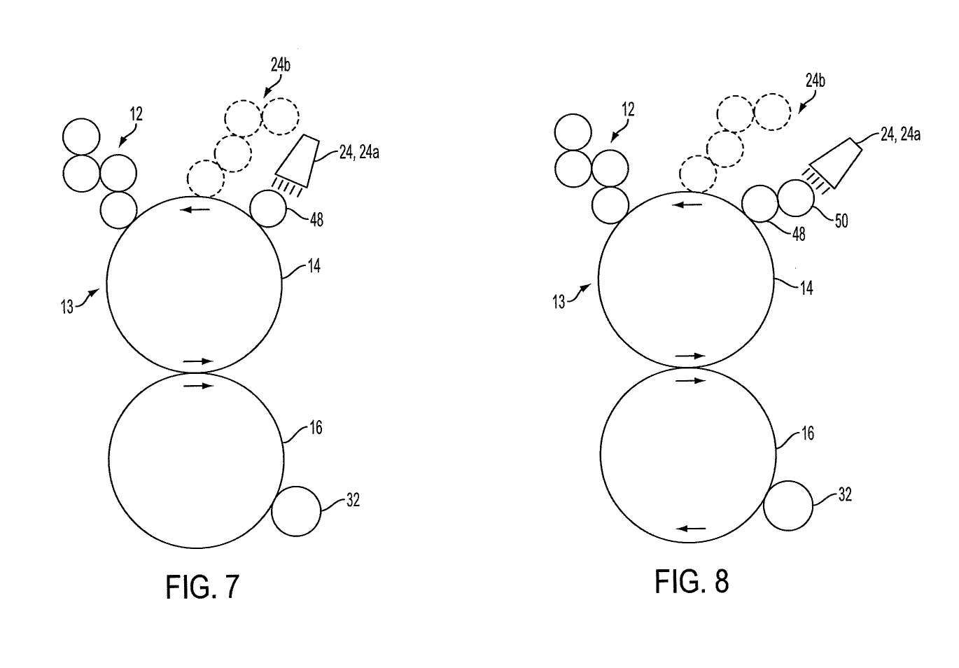

In addition, rather than using a belt printing plate 26 or in addition to such a belt printing plate 26, a single roller 48 as seen in FIG. 7 or a series of rollers 48, 50 as seen in FIG. 8 can also be used to receive the fountain solution from the applicator 24 and then transfer this solution to the belt printing plate 26 or to the printing plate 13 mounted onto the surface of printing plate cylinder 14. As indicted in FIGS. 7 and 8, the embodiment with the rollers 48 and/or 48, 50 are applicable to a system having only one variable pattern applicator 24 as seen in FIG. 3 or to a system like that shown in FIG. 5 with a variable pattern fountain solution applicator 24a and a traditional applicator 24b as will be described in more detail below. Only a portion of the printing press is shown in FIGS. 7 and 8. The structure beneath the printing plate 13 has been omitted for simplicity of illustration, but such structure is contemplated as being used with these embodiments. Moreover, while only two rollers are used in FIG. 8, any number or rollers or a belt could instead be used. As initially noted, the use of a single roller 48 or multiple rollers 48, 50 is also applicable with the embodiment using a belt printing plate 26 as shown in FIG. 4.

This belt printing plate 26 wraps around various rollers 28, 30 as shown. Of course, any number of rollers could be used to support and drive the belt printing plate 26. This belt printing plate 26 rotates past the fountain solution applicator 24, the ink rollers 12, the printing blanket 16 and the cleaning roll or other cleaning device 32. The ink transferred by the ink rollers 12 will be applied to the printing blanket 16 from the belt printing plate 26 and subsequently transferred to the substrate 22 such as paper. While paper may be noted, it should be appreciated that different substrates can receive the printed image. As noted, these substrates 22 can include various stocks of paper, paperboard, cardboard, glass, metal or any other known substrate, in either sheet-fed or continuous web form.

An advantage of the embodiment shown in FIG. 4 is that space is provided in the area of the fountain solution applicator 24 and the cleaning roll or other cleaning device 32. This physical space enables cleaning of the belt printing plate 26 before it gets new fountain solution and ink. The belt printing plate 26 may be made from material such as, but not limited to, rubber or plastic or composites of materials which provide necessary physical strength and flexibility and with a suitable surface texture and chemical makeup to adhere fountain solution and ink.

Turning to FIG. 5, a lithographic printing press modified with a fountain solution variable pattern applicator 24a in addition to a traditional roll, brush or spray type applicator 24b is shown. In this embodiment, the offset printing press of FIG. 3 is used in combination with a traditional applicator. Since the components as used in FIG. 3 are similar to that already described, their detailed description will not be repeated. The offset printing press includes the printing plate 13 on printing plate cylinder 14 which receives a fountain solution ejected by one or both of the fountain solution applicators 24a, 24b. Of course, rather than using a printing plate 13 mounted onto the surface of printing plate cylinder 14, a belt printing plate such as 26 or a single roller 48 or plural rollers 48, 50 could be used with the applicators 24a, 24b such as shown in FIGS. 7 and 8. These split fountain solution applicators 24a and 24b replace the single applicator 24 and will be described in more detail below. Downstream ink rollers 12, a printing blanket 16 and cleaning roll or other cleaning device 32 are also provided as has previously been described.

As noted, the fountain solution applicator components of FIG. 5 can be used in combination with an offset printing arrangement as described in FIG. 4, 7 or 8, although this arrangement is not shown. With the variable pattern applicator of FIG. 3, the fountain solution is applied directly to the printing plate 13 whereas in FIG. 4, a belt style continuous printing plate is used.

In FIG. 5, a traditional roll, brush or spray type applicator 24b is used. Such a traditional applicator 24b will result in the same image being applied to the substrate without the variability possible with the variable pattern fountain solution applicator 24a. In other words, this image resulting from applicator 24b can be varied, but in a traditional manner. This variation would only be after a printing run. In other words, the traditional applicator 24b would not vary the image during a printing run of the press 10. The image resulting from the variable fountain solution applicator 24a can be varied from print to print, or in any desired combination as has been discussed. In FIG. 5, the traditional applicator 24b is shown between the variable pattern fountain solution applicator 24a and the ink rollers 12. While fountain solution rollers 24b are shown in FIG. 5 as the traditional applicator, these could also be any traditional roll, brush or spray type applicator as noted above. Moreover, while FIG. 3 shows the traditional applicator 24b as being downstream from the variable pattern applicator 24a, it could in fact be upstream therefrom.

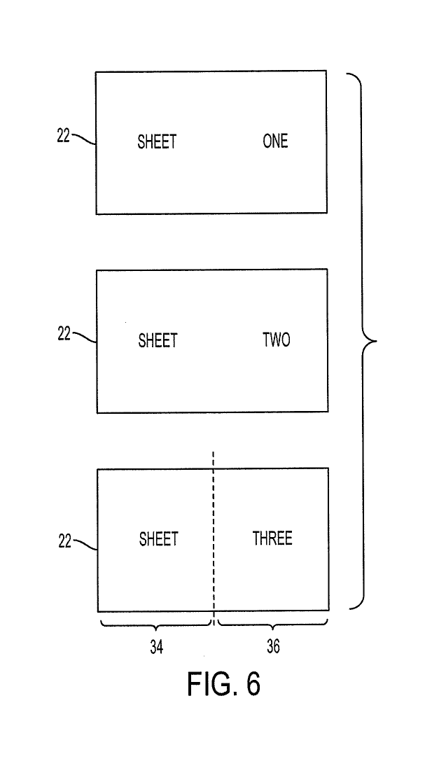

Turning to FIG. 6, the combination of the traditional and variable pattern applicators 24b, 24a will be explained. A substrate 22, such as a sheet of paper, can receive an image on one edge thereof which results from a traditional applicator and on another edge thereof, from the variable pattern applicator. In this example, the last printed sheet in the series of three sheets (the bottom sheet) has a dotted line to illustrate a separation of the image. The “SHEET” image on the left-edge 34 of the substrate results from the traditional applicator. This image is not varied from sheet to successive sheet in the run. The traditional applicator would enable ink to be picked up from the ink rollers 12 on the printing plate such that this “SHEET” image was placed on the left-edge 34 of the substrate 22. The right-edge 36 of the substrate 22 would receive a varying image for each sheet resulting from the fountain solution variable pattern applicator 24 or 24a. As shown in the series of three sheets, this image could vary from the numbers “ONE” to “TWO” to “THREE”. Of course, any desired image(s) could be printed. Moreover, the fountain solution variable pattern applicator 24, 24a could be selectively activated such that a desired series of sheets could be skipped and only selected sheets would have an image resulting from the variable pattern applicator. Moreover, as has been noted, the image resulting from the variable pattern applicator 24 or 24a does not have to be varied for each sheet as is shown in this example of FIG. 6. After a run, the image resulting from the traditional applicator 24b could be varied in the usual way. However, the variable pattern applicator image can be selectively varied as desired. Great flexibility is possible with the fountain solution applicator of the present invention.

While the image resulting from the traditional applicator 24b is shown on the left-edge 34 of the sheet and the variable pattern applicator resulting image is on the right-edge 36 of the sheet, these edges could be varied depending upon where the applicators 24a, 24b are mounted relative to the length of the printing plate 14. When viewed in FIG. 5, for example, the traditional fountain solution applicator 24b would be closer to the viewer while the variable fountain solution applicator 24a would be further away. This perspective is not readily visible in the current FIG. 5 due to its schematic nature. However, this arrangement should be apparent from the foregoing description. Such positioning of the applicators 24a, 24b could be reversed with the traditional fountain solution applicator 24b being further away than the variable fountain solution applicator 24a in this FIG. 5. Basically, the positioning of the applicators 24a, 24b can be varied along the length of the printing plate 13 as noted. The press can be arranged to have the various applicators 24a, 24b fixed in position or movably mounted to thereby change their position relative to the printing plate 13. Alternatively, the traditional applicator 24b could be arranged to print all but a small box or text field within the image on the substrate, whereas the variable pattern applicator could then be used to fill in this box or text field. In another arrangement, the variable pattern applicator 24a could be positioned between two traditional applicators 24b, such that a middle portion of the image can be selectively varied by the variable pattern applicator 24a while the two edges of the image were consistently applied from the two traditional applicators. In FIG. 5, one traditional applicator 24b is shown. Another traditional applicator would be behind this shown applicator 24b and not visible in this view. Alternately, this second applicator could be at some other offset position around the circumference of the printing plate 13. It could be the situation that the second traditional applicator is present, but is switched “off” so that only the one traditional applicator 24b and the variable fountain solution applicator 24a are used. Moreover, more than two traditional applicators 24b could be present. They could be the same type of applicator such as the indicated roll applicator, or they could be brush or spray type applicators. The same or different types of applicators could be used. Like the traditional applicators 24a, one or any multiple of variable fountain solution applicator 24a could be used. It should be appreciated that other combinations or arrangements of traditional and variable pattern applicators could be used. The invention thereby provides great flexibility. It should also be appreciated that the press could have such applicators permanently or temporarily mounted thereon. Thus, depending on the needs of the printing job, the press can be easily modified to accommodate the needed requirements.

With the printing press 10 of the present invention, a method for applying an image to a substrate 22 is provided. The printing press 10 has a rotatable printing plate 13 which can include printing cylinder 14 or belt printing plate 26. As has been noted above, when the printing plate is referred to herein, either a rotating printing plate mounted onto the surface of a printing plate cylinder or rotatable belt can be used. The method will apply fountain solution in a predetermined pattern from an applicator such as 24, 24a, 24b onto the printing plate 13 or a single roller 48 or plural rollers 48, 50. As has been noted, when using rollers 48 and 50, any number of rollers can actually be used. Ink is then supplied by the ink rollers 12 or any other known device. The ink will temporarily adhere to the printing plate 13 in areas which are free of the fountain solution applied to the printing plate 13. The ink is then transferred from the printing plate 13 to a printing blanket 16 and subsequently to the substrate 22 to form an image on the substrate.

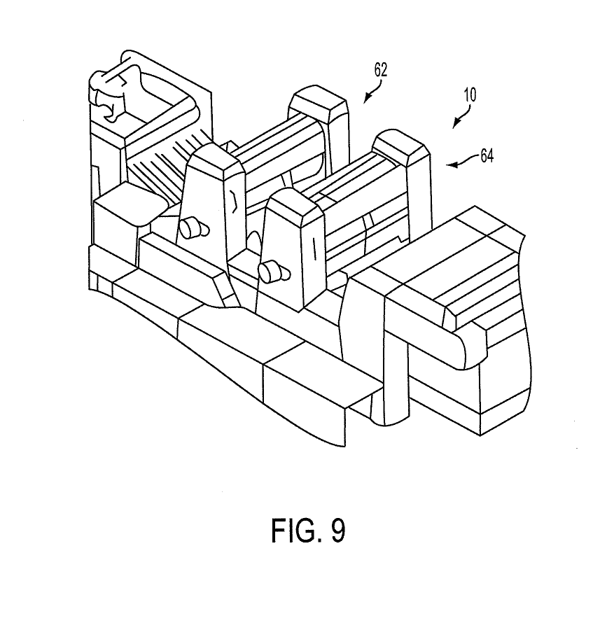

In FIG. 9, a printing press 10 has a plurality of towers 62, 64. Of course, any number of towers can be used. Such an arrangement can be for separate color printing. One or more of the towers can have one or more of the fountain solution applicators 24 and/or 24a, 24b which have been described above. For example, a traditional fountain solution applicator 12 can be in one tower 62 with the variable fountain solution applicator 24 in another tower 64. This is but one example of the different combinations which can be utilized in such a printing press 10. For example, the inventive fountain solution applicators can be used in a press using a four color image traditional printing followed by a fifth printing tower that would impart variable information such as a name and mailing address on the substrate.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A fountain solution applicator for a printing press having a rotatable printing plate, the applicator having an outlet for releasing fountain solution onto the plate in a variable image whereby a fountain solution pattern is frequently changeable.

2. The fountain solution applicator of claim 1, wherein the applicator selectively applies a varied pattern of fountain solution directly onto the printing plate on a rotatable cylinder or onto a belt printing plate or onto rollers that subsequently transfer the varied pattern onto the printing plate.

3. The fountain solution applicator of claim 2, wherein the ejector ejects droplets of fountain solution.

4. The fountain solution applicator of claim 2, wherein the fountain solution pattern is varied for each rotation of the plate.

5. The fountain solution applicator of claim 1, wherein the applicator selectively applies the pattern of fountain solution onto the rotatable plate during a printing run whereby the pattern is changeable without stopping rotation of the printing plate.

6. The fountain solution applicator of claim 1, wherein the printing plate is on a rotatable cylinder or is a rotatable belt printing plate.

7. A printing press having:
a rotatable printing plate;
a rotatable printing blanket;
a rotatable impression cylinder, a path for a substrate to receive an image being formed between the printing blanket and the impression cylinder; and
an applicator for applying a fountain solution to the printing plate in a variable image whereby a fountain solution pattern is frequently changeable.

8. The printing press as recited in claim 7, further comprising:
ink rollers adjacent to the printing plate and downstream from the fountain solution applicator; and
a cleaning device adjacent the printing plate and downstream from a nip of the printing blanket and rotatable printing plate.

9. The printing press according to claim 7, comprising a drive for rotating the printing plate cylinder having the printing plate, the printing blanket and the rotatable impression cylinder, the applicator applying a fountain solution to the printing plate in a variable pattern.

10. The printing press according to claim 9, wherein the pattern applied by the applicator varies for each rotation of the printing plate.

11. The printing press according to claim 9, wherein the applicator selectively ejects fountain solution onto the printing plate whereby the pattern is changeable without stopping rotation of the printing plate.

12. The printing press according to claim 7, wherein the printing plate is mounted on a rotatable cylinder or is a rotatable belt printing plate.

13. The printing press according to claim 7, further comprising a second fountain solution applicator used in combination with the applicator for applying a fountain solution, an image resulting from the second fountain solution applicator being constant whereas an image from the applicator for applying fountain solution being selectively varied during a run of the printing press, the second fountain solution applicator being one of a roll, brush or spray applicator.

14. The printing press according to claim 7, wherein the printing press has plural towers with at least one of the towers having the applicator for applying fountain solution in the variable image.

15. A method for applying an image to a substrate, the method comprising the steps of:
providing a printing press with a rotatable printing plate;
applying a fountain solution in a predetermined pattern from an applicator onto the printing plate, the fountain solution being applied in a variable image whereby a fountain solution pattern is frequently changeable;
supplying ink to the printing plate, the ink temporarily adhering to the plate in areas which are free of the fountain solution applied to the plate;
transferring the ink from the plate to a printing blanket and subsequently to the substrate to form an image thereon.

16. The method of claim 15, further comprising the step of removing any remaining ink and fountain solution from the printing plate after the step of transferring.

17. The method of claim 15, further comprising the steps of;
rotating the printing plate;
applying the fountain solution to the plate during rotation thereof; and
applying ink to the printing plate during rotation of the plate and after application of the fountain solution.

18. The method of claim 17, further comprising the step of selectively varying the pattern of fountain solution applied by the applicator during a printing run of the printing press.

19. The method of claim 18, further comprising the step of varying the pattern of the fountain solution for each rotation of the printing plate.

20. The method of claim 18, wherein the step of applying fountain solution comprises:
ejecting solution from the applicator onto one of the printing plate or a roller or rollers; and
if the fountain solution is on the roller or roller, then transferring the fountain solution to the printing plate.

21. The method of claim 18, further comprising the step of applying a second fountain solution applicator onto the printing plate, one application of fountain solution being carried out ejecting fountain solution in a pattern that is variable and another of the applications being carried out by a second fountain solution applicator, the second fountain solution applicator being a roll, brush or spray applicator and failing to vary the image during the printing run of the printing press.
